(19) United States
(12) Patent Application Publication
(10) Pub. No.: US 2009/0290340 A1
(43) Pub. Date: Nov. 26, 2009

(54) Lighting Device

(75) Inventor: Yasuhiro Hayakawa, Tokyo (JP)

Correspondence Address: JORDAN AND HAMBURG LLP, 122 EAST 42ND STREET, SUITE 4000, NEW YORK, NY, 10168, US

(73) Assignee: SHOWA DENKO K.K., Minato-ku (JP)

(21) Appl. No.: 12/227,621

(22) PCT Filed: Feb. 7, 2008
(86) PCT No.: PCT/JP2008/052033

§ 371 Date: Feb. 9, 2009

(30) Foreign Application Priority Data
Feb. 13, 2007 (JP) 2007-031632

(51) Int. Cl. F21V 1/00

(52) U.S. Cl. 362/235

(57) ABSTRACT

A lighting device with a plurality of light-emitting elements such as light-emitting diodes disposed in an in-line configuration at regular interval on a base plate; and a plurality of reflectors attached to the base plate, the plurality of reflectors being so formed as to cover each of the light-emitting diodes with mixed reflecting surfaces structured by reflecting surfaces which are planar except their lower portions, the planar reflecting surfaces being perpendicular to in-line direction of the light-emitting elements such as diodes, and other side surfaces which are able to mix reflected lights from the light-emitting elements; therefore, the present invention provides economical lighting devices which can illuminate relatively wide area nearly evenly by effectively mixing the lights from the light-emitting elements such as light-emitting diodes, and further which can be used like conventional electric lamps and fluorescent lights.

### BACKGROUND OF THE INVENTION

1. Field of the Invention

The present invention relates to lighting devices that use a plurality of light-emitting elements, such as light-emitting diodes, as light source.

2. Description of the Related Art

Conventional lighting devices of this kind are comprised of: a light-emitting portion having a plurality of light-emitting diodes disposed on a base; a first reflecting portion, having paraboloidal surfaces of which focal position to be light-emitting faces of the light-emitting diodes, the first reflecting portion being disposed on a light outgoing side of the light-emitting portion corresponding to each of the plurality of light-emitting diodes; and a second reflecting portion having planar reflecting surfaces which reflect the lights from the light-emitting diodes toward the light outgoing side, the second reflecting portion being disposed in a pair in parallel to an alignment direction of the light-emitting diodes across the light-emitting diodes.

A disadvantage of the conventional lighting devices as constructed above lies in the fact that the lights from the light-emitting diodes go straight and that the lights from the first and the second reflecting portions also go straight, thus limiting the application of the conventional lighting devices to illumination of relatively narrow area, not being as usable as conventional electric lamps or fluorescent lights.

In view of the foregoing disadvantage, it is an object of the present invention to provide economical lighting devices which can illuminate relatively wide area nearly evenly, being usable like conventional electric lights and fluorescent lights, by effectively mixing the lights from light-emitting elements, such as light-emitting diodes.

The above and further objects and novel features of the present invention will more fully appear from the following detailed description when the same is read in connection with the accompanying drawings. It is to be understood that these are for purpose of illustration only and are not intended to be a definition of the limits of the invention.

### SUMMARY OF THE INVENTION

In order to implement the above objective, the present invention provides lighting devices which are comprised of: a plurality of light-emitting elements, such as light-emitting diodes, disposed in in-line configuration at regular interval on a base plate; and a plurality of reflectors attached to the base plate, the plurality of reflectors being so formed as to cover each of the light-emitting diodes with mixed reflecting surfaces structured by reflecting surfaces which are planar except their lower portions, the planar reflecting surfaces being perpendicular to in-line direction of the light-emitting elements such as diodes, and other side surfaces which are able to mix reflected lights from the light-emitting elements.

As is clear from the above-mentioned explanations, the present invention as hereinabove defined provides the effects enumerated below.

(1) The lighting device is comprised of: a plurality of light-emitting elements, such as light-emitting diodes, disposed in in-line configuration at regular interval on a base plate; and a plurality of reflectors attached to the base plate, the plurality of reflectors being so formed as to cover each of the light-emitting diodes with mixed reflecting surfaces structured by reflecting surfaces which are planar except their lower portions, the planar reflecting surfaces being perpendicular to in-line direction of the light-emitting elements such as diodes, and other side surfaces which are able to mix reflected lights from the light-emitting elements.

Therefore, the plurality of mixed reflecting surfaces of the reflectors can effectively mix the straight-going lights from the light-emitting elements, such as light-emitting diodes, and can illuminate a relatively wide area, which feature makes the lighting device usable like conventional electric lights and fluorescent lights.

(2) According to the above (1) the reflectors are replaceable; therefore it can have a simple structure and can be manufactured at low cost.

(3) According to the above (1) the planar reflecting surfaces of the reflectors and the mixed reflecting surfaces mix the emission from the light-emitting elements, such as light-emitting diodes, making light sources blur; therefore it can provide an illumination condition closer to that of fluorescent light.

(4) Another embodiment has the same effects as the above (1) to (3), and it can illuminate desired area with ease of use.

(5) Another embodiment has the same effects as the above (1) to (3), and it can mix the lights from light-emitting diodes more firmly.

(6) Another embodiment has the same effects as the above (1) to (3), and the reflector is an integrated part so that it can have a simple structure and offers cost reduction.

### BRIEF DESCRIPTION OF DRAWINGS

FIG. 1 is an in-use vertical cross-section view showing a first preferred embodiment of the present invention;

FIG. 2 is an in-use enlarged horizontal cross-section view showing the first preferred embodiment of the present invention;

FIG. 3 is a bottom view of FIG. 1;

FIG. 4 is a front view showing the first preferred embodiment of the present invention with a lighting-device casing being removed therefrom;

FIG. 5 is a back view showing the first preferred embodiment of the present invention with the lighting-device casing being removed therefrom;

FIG. 6 is a side view showing the first preferred embodiment of the present invention with the lighting-device casing being removed therefrom;

FIG. 7 is a front view of a reflector unit showing the first preferred embodiment of the present invention;

FIG. 8 is a cross-section view taken along a line of 8-8 in FIG. 7;

FIG. 9 is a cross-section view taken along a line of 9-9 in FIG. 7;

FIG. 10 is an explanatory drawing showing the first preferred embodiment with the lighting-device casing being rotatably attached thereto;

FIG. 11 is an in-use vertical cross-section view showing a second embodiment of the present invention;

FIG. 12 is an in-use enlarged horizontal cross-section view showing the second embodiment of the present invention;

FIG. 13 is a bottom view of FIG. 11;

FIG. 14 is an in-use vertical cross-section view showing a third embodiment of the present invention;

FIG. 15 is an in-use enlarged horizontal cross-section view showing the third embodiment of the present invention;

FIG. 16 is a bottom view of FIG. 14;

FIG. 17 is an in-use vertical cross-section view showing a fourth embodiment of the present invention;

FIG. 18 is an in-use enlarged horizontal cross-section view showing the fourth embodiment of the present invention;

FIG. 19 is a bottom view of FIG. 17;

FIG. 20 is an in-use vertical cross-section view showing a fifth embodiment of the present invention;

FIG. 21 is an in-use enlarged horizontal cross-section view showing the fifth embodiment of the present invention;

FIG. 22 is a bottom view of FIG. 20;

FIG. 23 is an in-use vertical cross-section view showing a sixth embodiment of the present invention;

FIG. 24 is an in-use enlarged horizontal cross-section view showing the sixth embodiment of the present invention;

FIG. 25 is a bottom view of FIG. 23;

FIG. 26 is a front view showing the sixth embodiment of the present invention with the lighting-device casing being removed therefrom;

FIG. 27 is a front view of the reflector unit showing the sixth-embodiment of the present invention;

FIG. 28 is a cross-section view taken along a line of 28-28 in FIG. 27; and

FIG. 29 is a cross-section view taken along a line of 29-29 in FIG. 27.

### DETAILED DESCRIPTION OF THE INVENTION

Preferred embodiments of the present invention will now be described in detail below referring to the accompanying drawings.

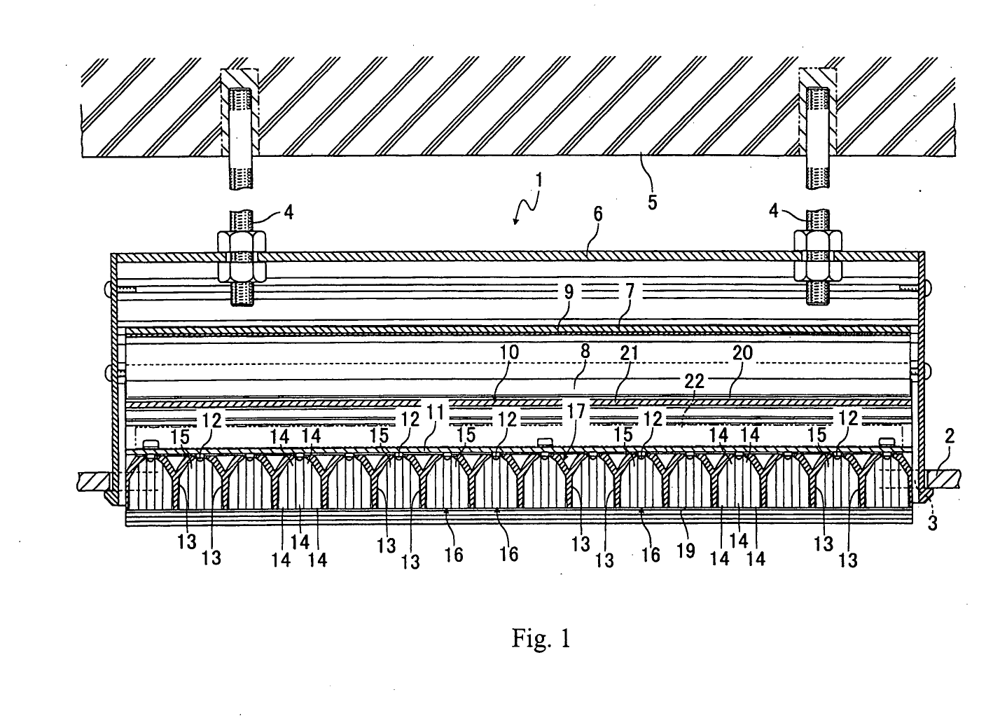

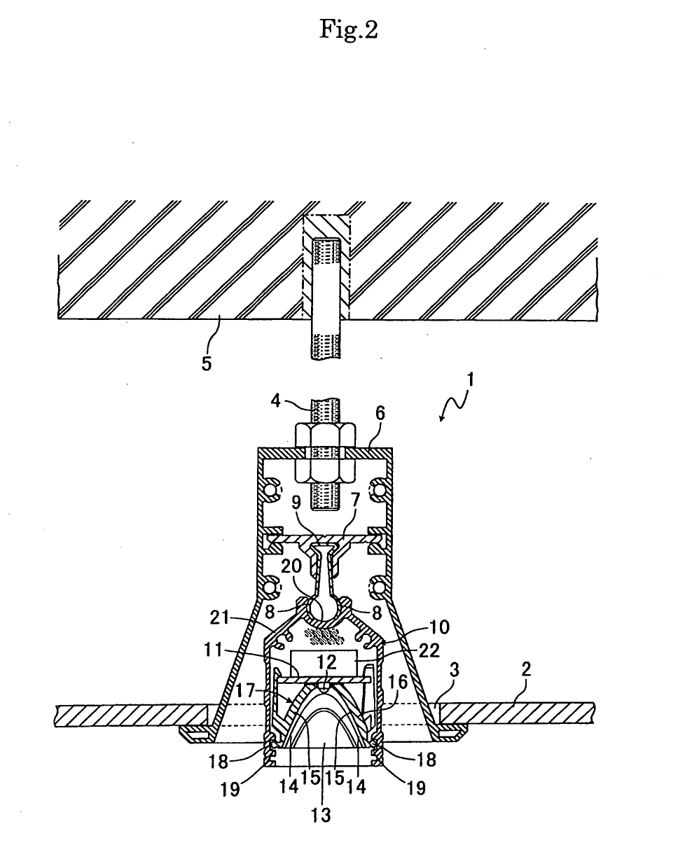

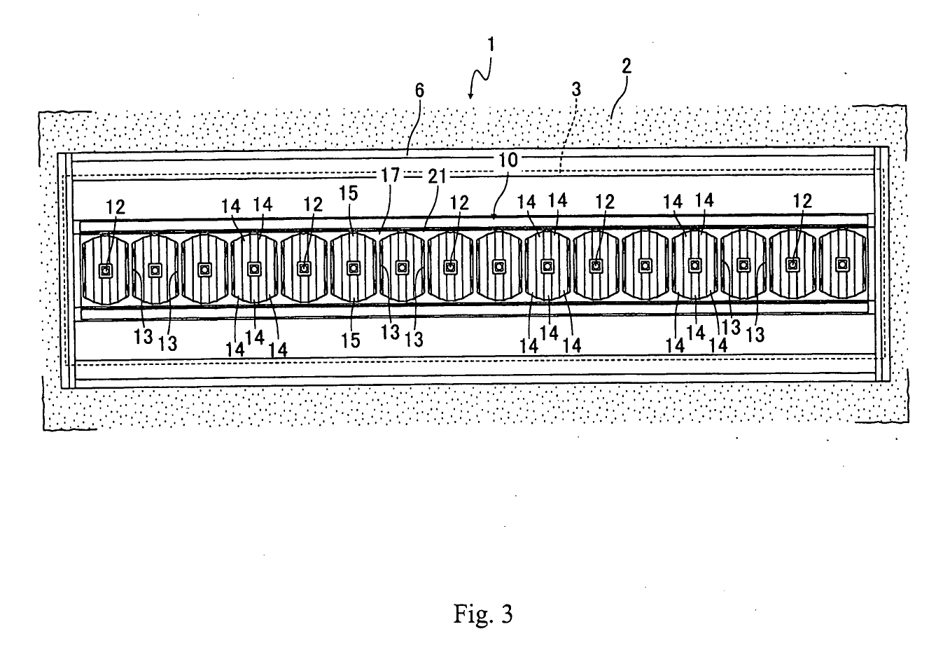

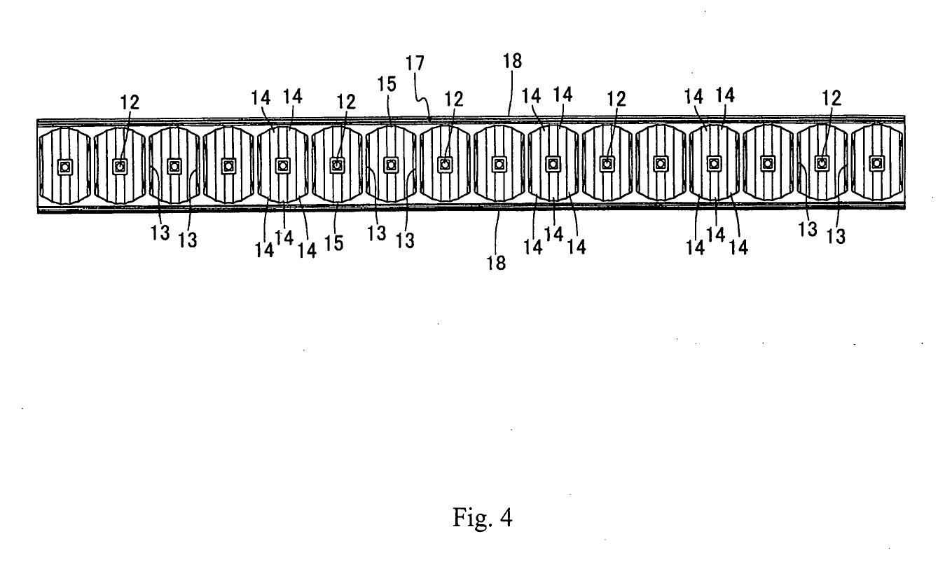

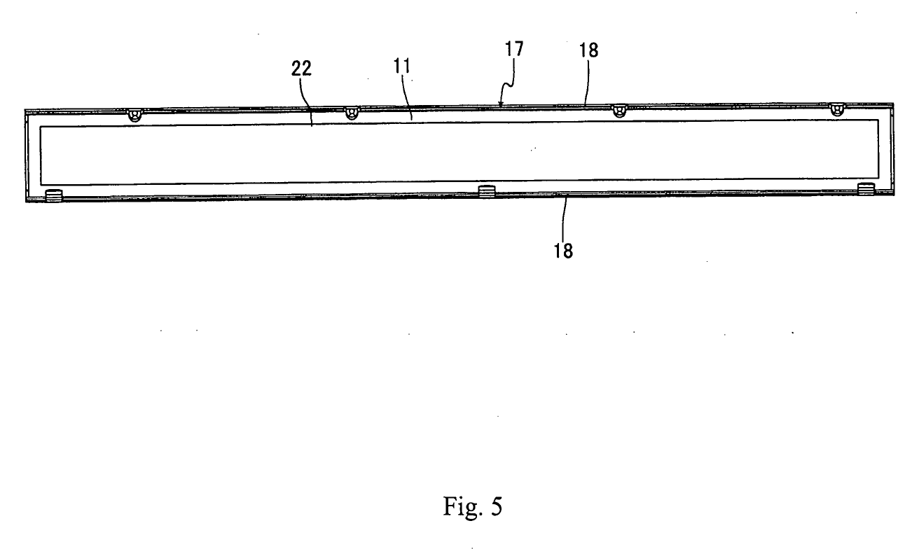

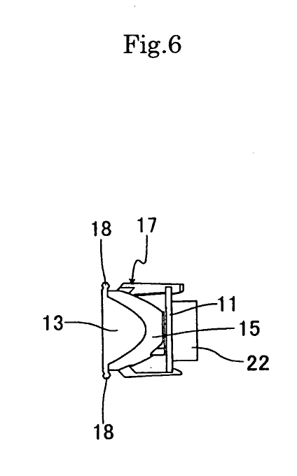

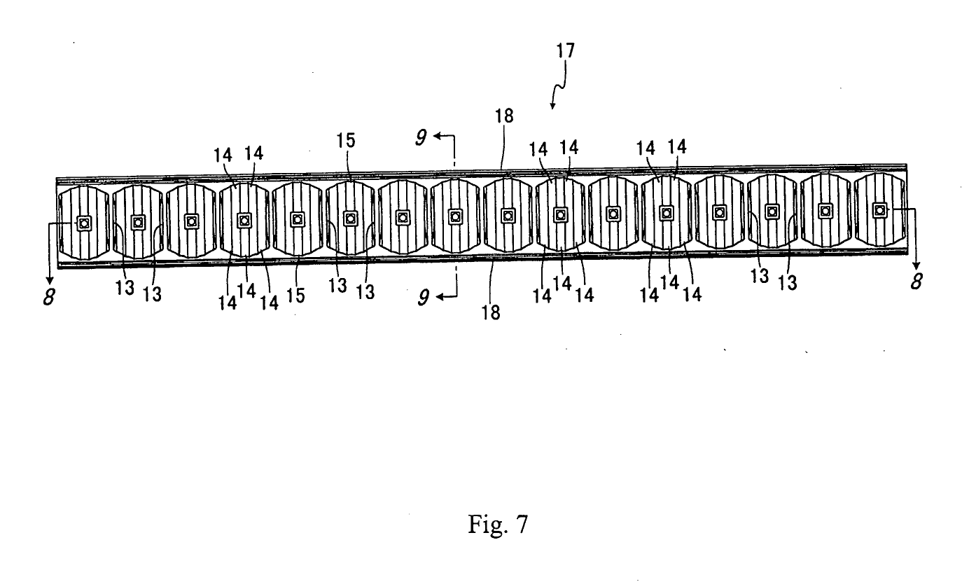

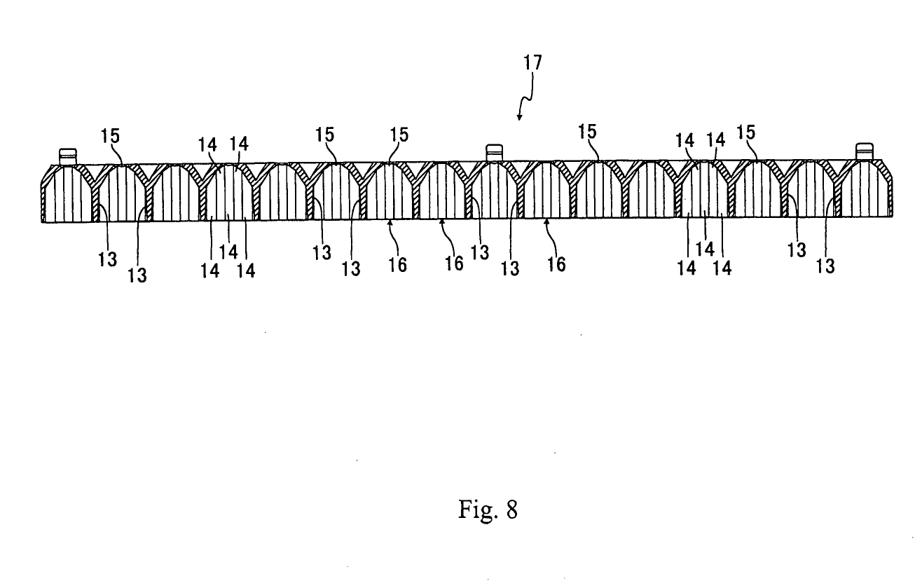

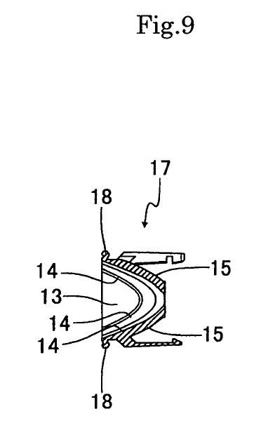

FIGS. 1 to 10 illustrate a first preferred embodiment of the present invention wherein 1 is a lighting device of the present invention, the lighting device being comprised of: an outer hood 6 which is fixed with stud bolts 4 to a ceiling body 5 so as to cover an open-hole 3 formed in a ceiling cover panel 2, the outer hood 6 broadening towards the open-hole 3; and a lighting device main body 10 which is attached to a support body 9 allowing it to be rotatable sideways a certain amount, the support body 9 having a pair of arc-shaped elastic support bulges 8, 8 at its bottom end, and is attached to a mounting plate 7 detachably attached in the outer hood 6.

The lighting device main body 10 is comprised of: an elongated planar base plate 11; a plurality of light-emitting elements 12, such as light-emitting diodes, disposed in in-line configuration at regular interval on the base plate 11; a reflector unit 17 attached to the base plate 11 which integrally incorporates a plurality of reflectors 16 covering each of the light-emitting elements 12 formed on mixed reflecting surfaces 15, 15 structured by reflecting surfaces 13, 13 which are planar except their lower portions, the planar reflecting surfaces being perpendicular to in-line direction of the light-emitting elements 12, such as light-emitting diodes, and other side surfaces which are a plurality, five in this embodiment, of arc-shaped surfaces 14, 14, 14, 14, 14 being able to mix reflected lights from the light-emitting elements; a lighting-device casing 21 which covers the base plate 11 and the reflector unit 17 forming therein an engagement-groove 20 having engagement-catchers 19, 19 which detachably engage with engagement-fringes 18, 18 integrally formed on both inner wall surfaces of distal end, the engagement-groove 20 being able to be attached rotatably and adjustably over the support bulges 8, 8; and a control circuit 22 attached to the base plate 11.

The above constructed lighting device I is attached to the ceiling cover panel 2 to illuminate a room or a hallway. When illuminating, the lights from the plurality of light-emitting elements 12, such as light-emitting diodes, are mixed with reflection by a plurality of reflecting surfaces 13, 13 of a plurality of reflectors 16 of the reflector unit 17, and the mixed reflecting surfaces 15, 15, so that a relatively wide area can be illuminated.

Therefore, it can be used as an alternative energy-saving illumination to conventional fluorescent lights.

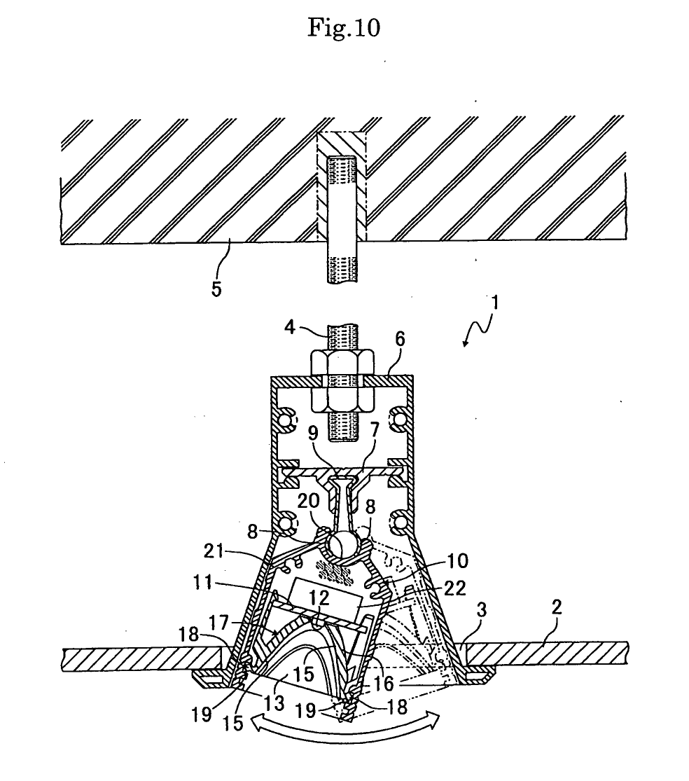

Also, by setting the lighting-device casing 21, the supporting bulges 8, 8 of the support body 9 being engaged therein in rotatable arrangement as shown in FIG. 10, the plurality of light-emitting elements 12 such as light-emitting diodes can adjustably illuminate desired area.

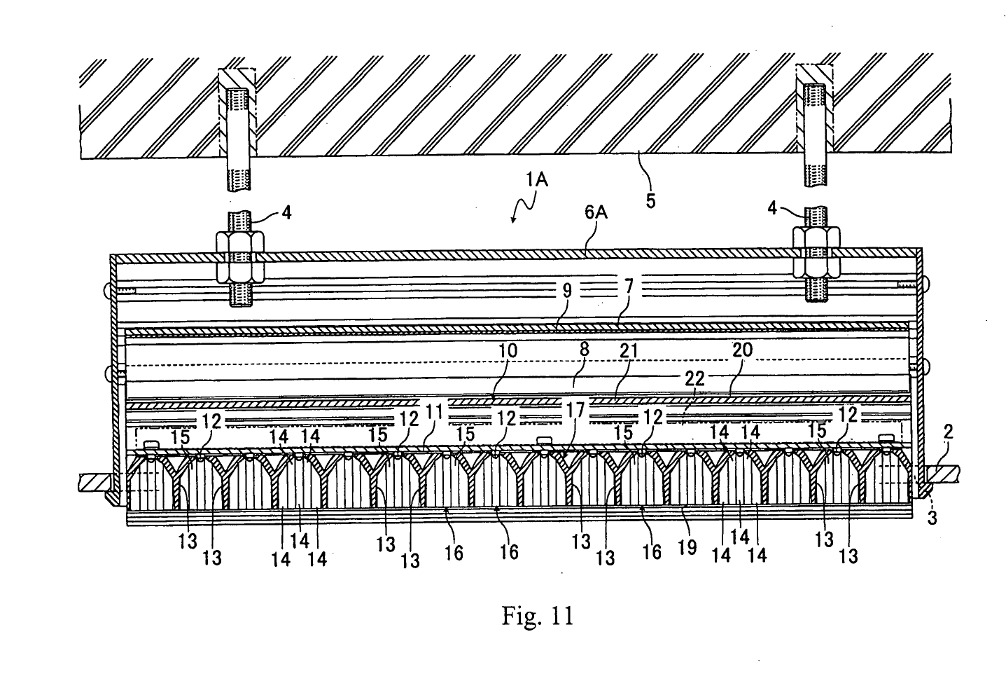

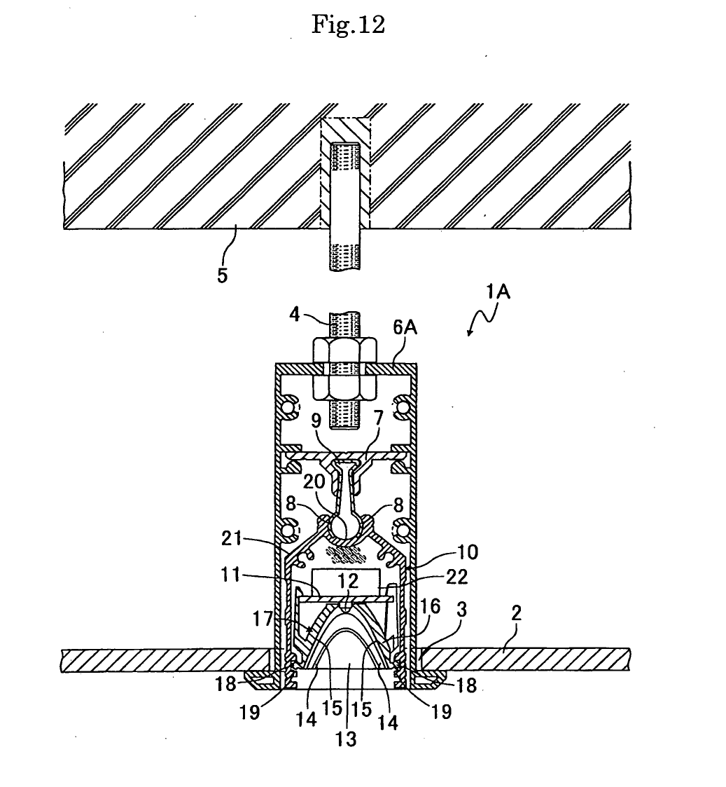

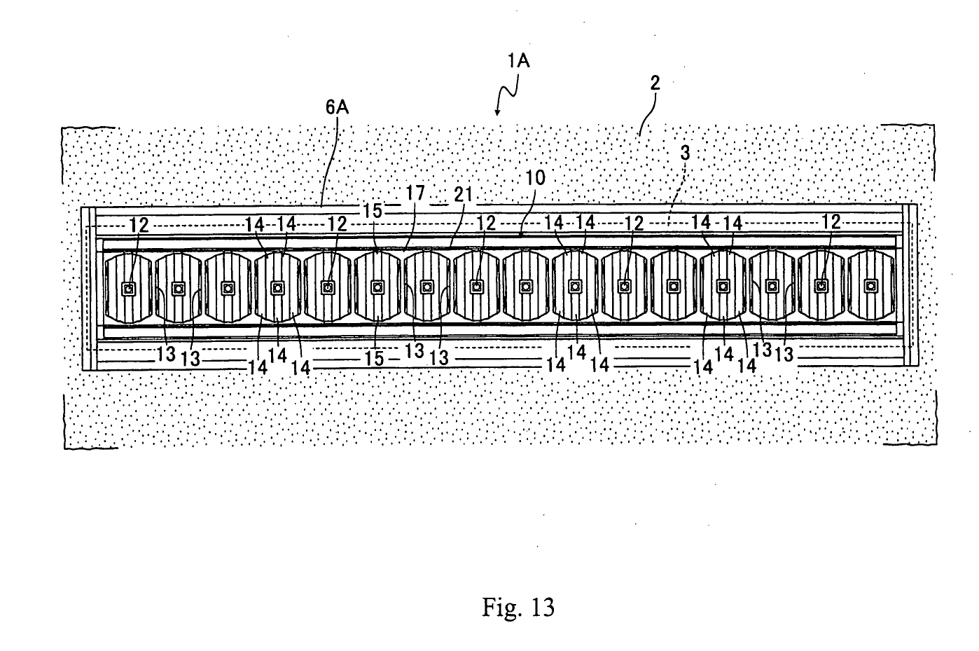

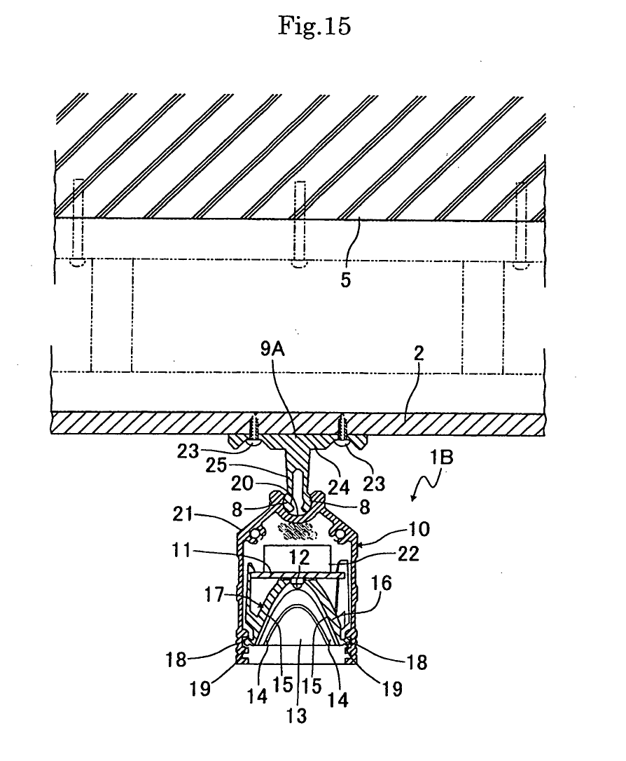

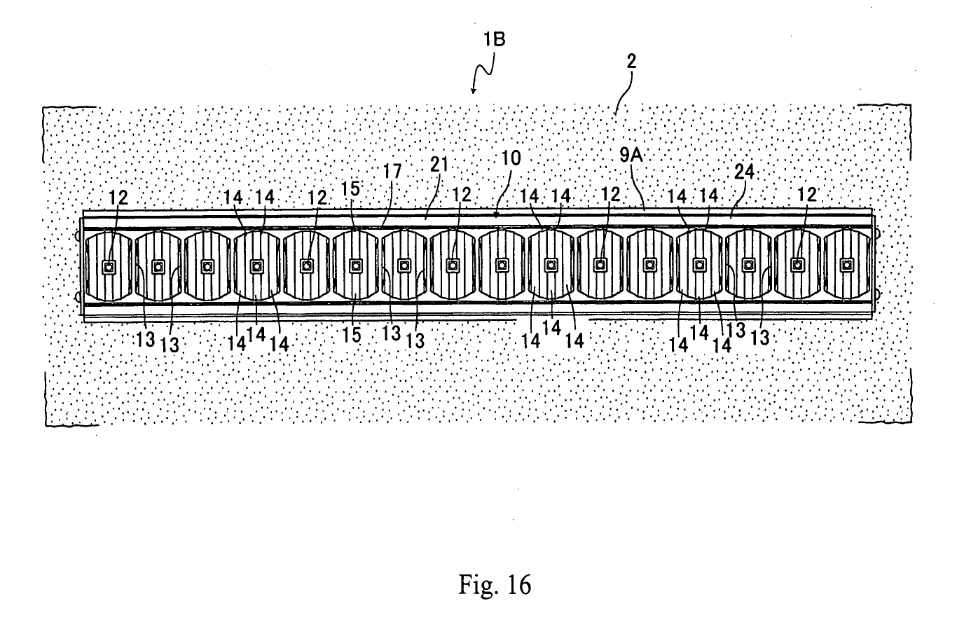

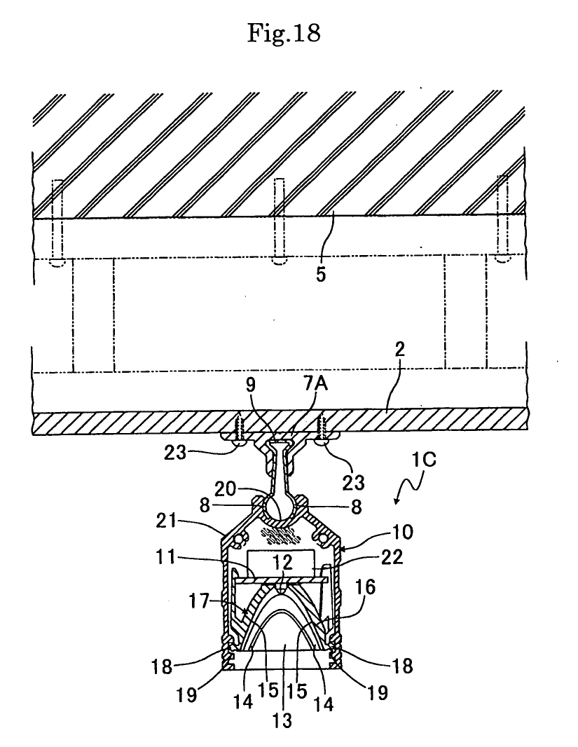

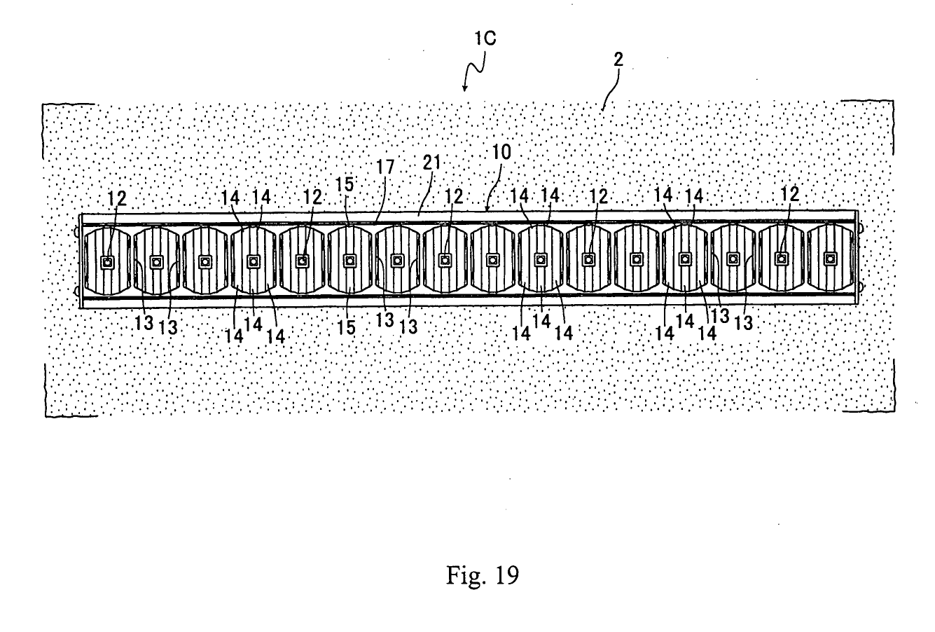

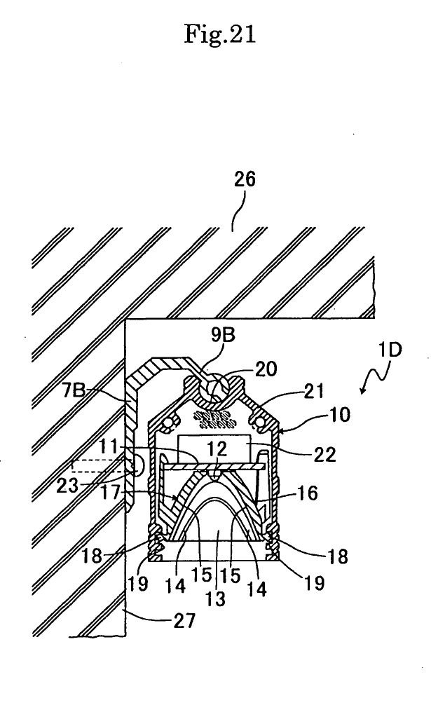

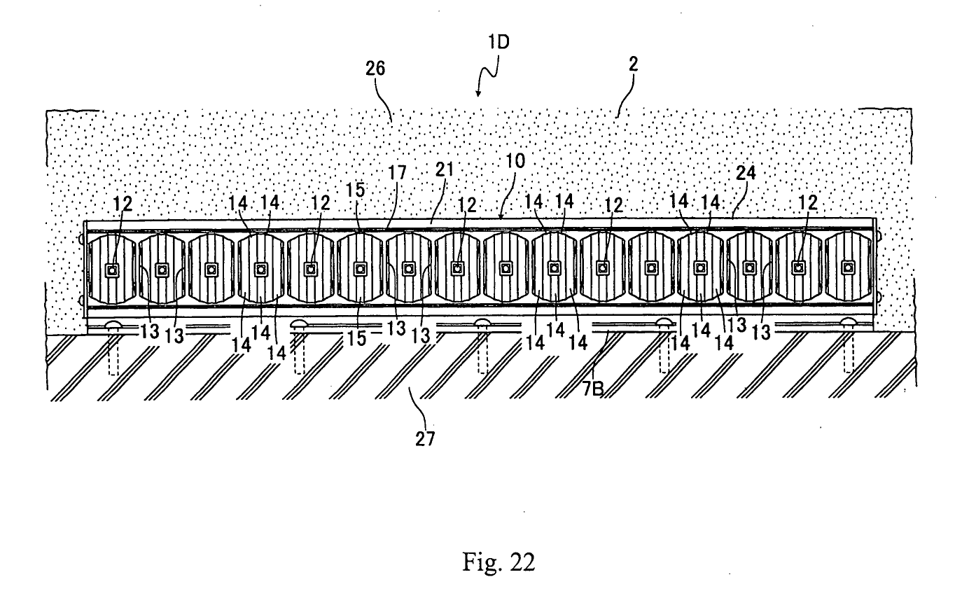

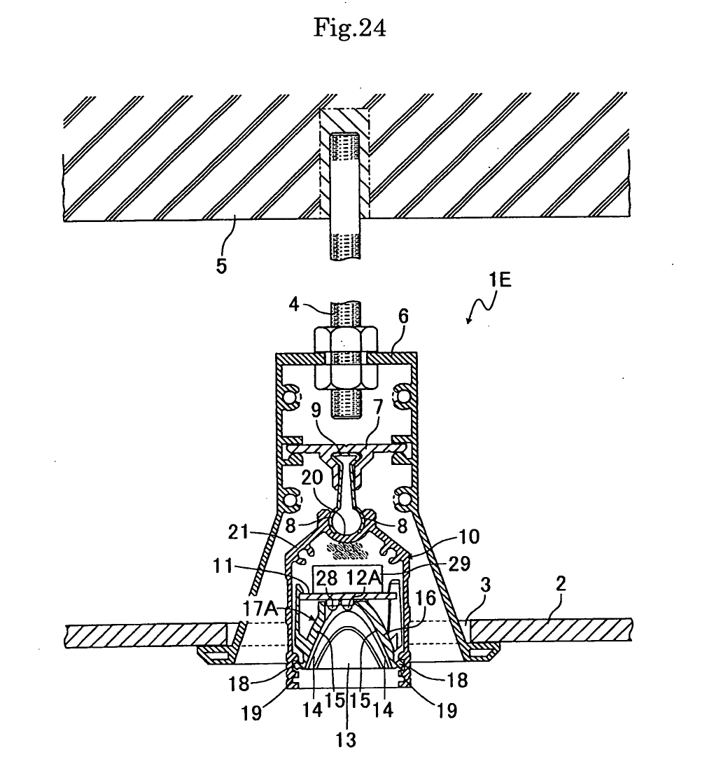

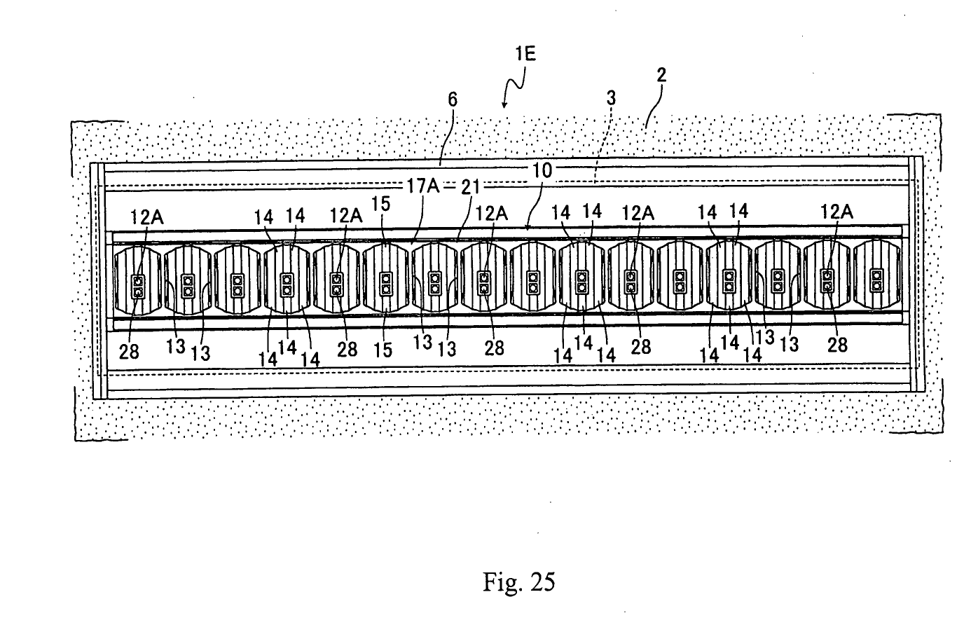

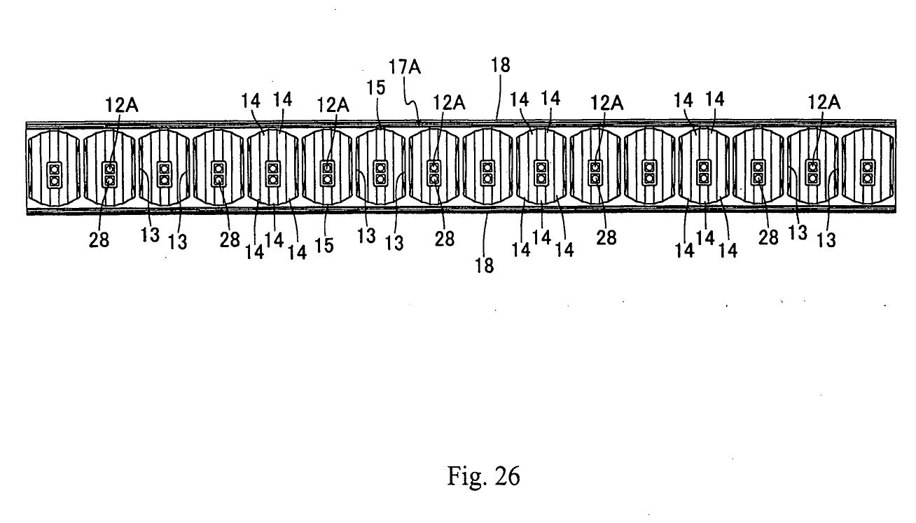

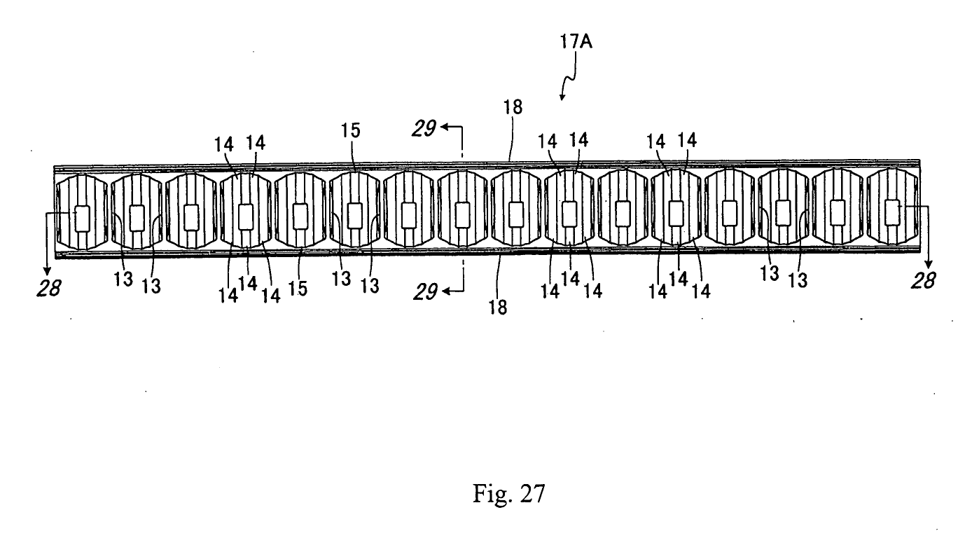

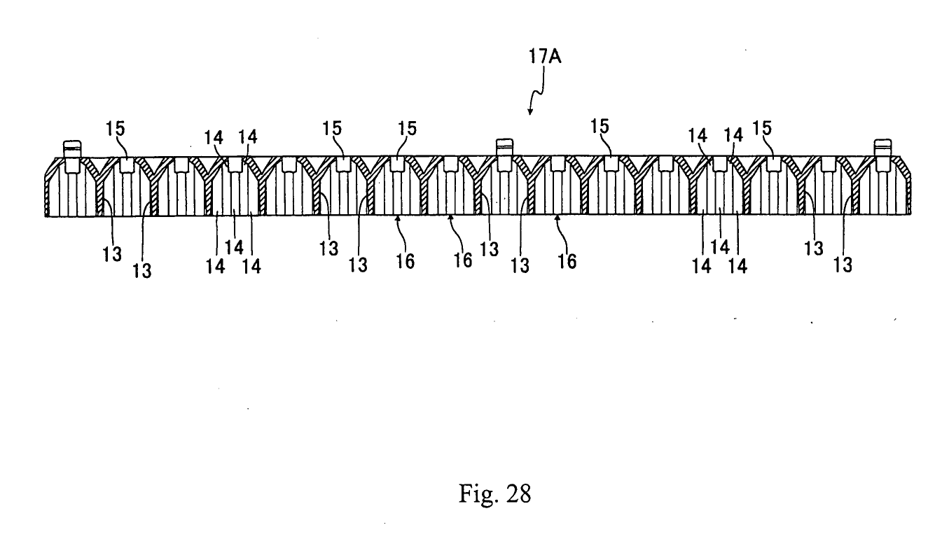

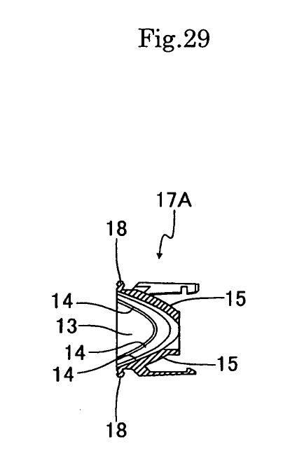

Explained next are other embodiments of the present invention as illustrated in FIGS. 11 to 29. In explaining these other embodiments of the present invention, the same component parts as those in the first preferred embodiment of the present invention, are given the same numerals in order to avoid overlapping explanations.

A second embodiment of the present invention is shown in FIGS. 11 to 13 and is distinguished from the first preferred embodiment by the fact that the lighting-device casing 21 is attached in an outer hood 6A which is non-rotatable sideways. A lighting device 1A of which the lighting-device casing 21 is attached in the outer hood 6A can provide similar advantages to that according to the first preferred embodiment of the present invention.

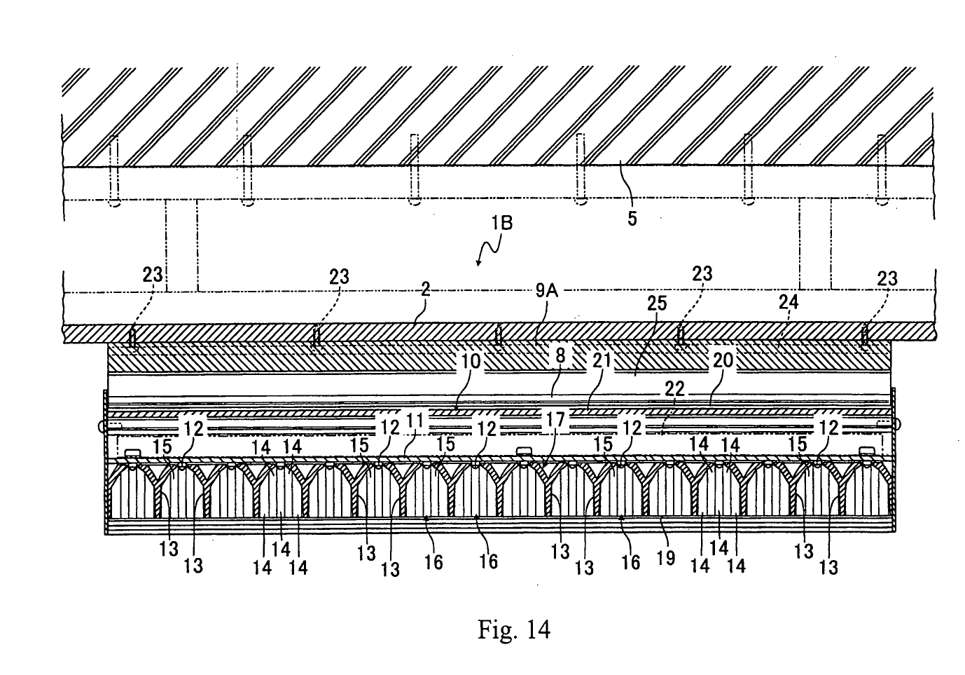

A third embodiment of the present invention is shown in FIGS. 14 to 16 and is distinguished from the first preferred embodiment by the fact that the C-letter-shaped engagement groove 20 of the lighting-device casing 21 is rotatably and adjustably attached to the arc-shaped elastic support bulges 8, 8 at the end of a support extension 25 integrally molded with a mounting base plate portion 24 of a support body 9A which is fixed to the ceiling cover panel 2 with a plurality of screws 23. A lighting device 1B composed in this way can provide similar advantages to that according to the first preferred embodiment of the present invention.

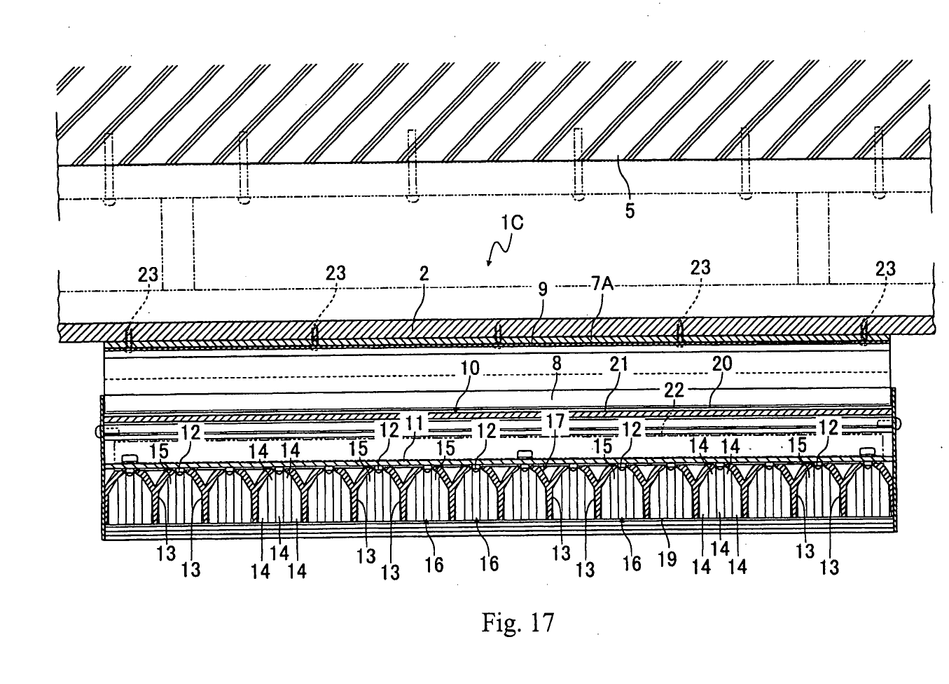

A fourth embodiment of the present invention is shown in FIGS. 17 to 19 and is distinguished from the first preferred embodiment by the fact that the support body 9, which is rotatably and adjustably attached to the engagement-groove 20 of the lighting-device casing 21, is attached to a mounting plate 7A which is fixed to the ceiling cover plate 2 with the plurality of screws 23. A lighting device IC composed in this way can provide similar advantages to that according to the first preferred embodiment of the present invention.

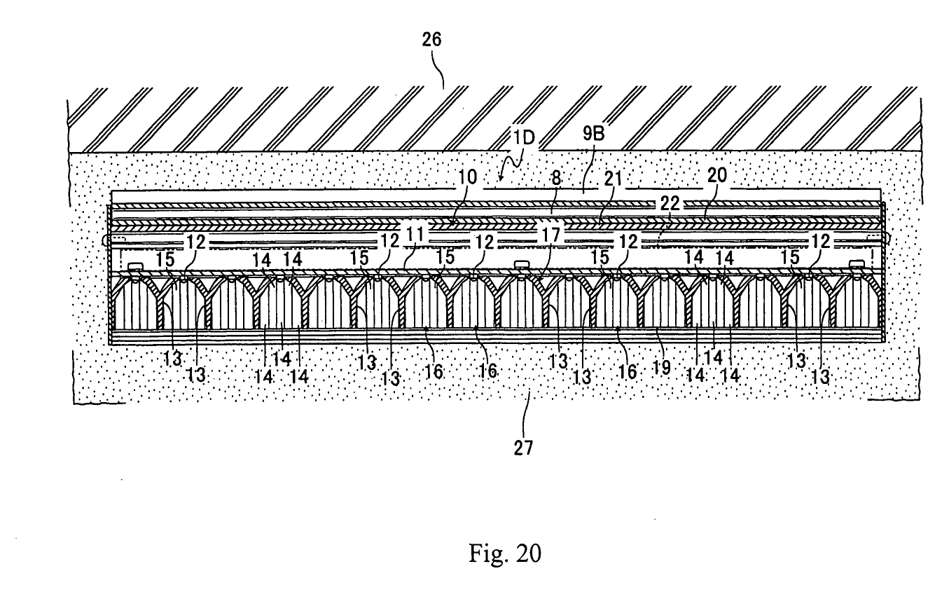

A fifth embodiment of the present invention is shown in FIGS. 20 to 22 and is distinguished from the first preferred embodiment by the fact that a mounting plate 7B is integrally molded with a support body 9B, which is rotatably and adjustably attached to the engagement-groove 20 of the lighting-device casing 21, the mounting plate 7B being able to be fixed to a wall surface 27 of a reverse-L-shaped building 26 with the plurality of screws 23. A lighting device ID composed in this way can provide similar advantages to that according to the first preferred embodiment of the present invention.

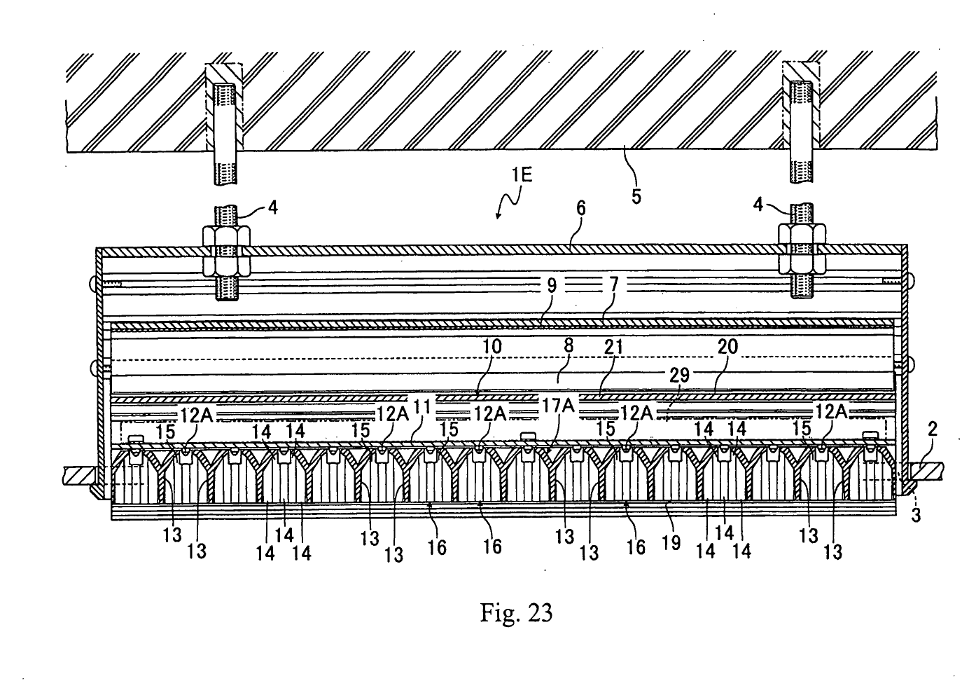

A sixth embodiment of the present invention is shown in FIGS. 23 to 29 and is distinguished from the first preferred embodiment by the fact that: the plurality of reflectors 16 are integrally formed comprising the mixed reflecting surfaces 15, 15 comprising the planar reflecting surfaces 13, 13, 13, and the five arc-shaped surfaces 14, 14, 14, 14, 14; and that white-light-emitting elements 12A and RBG-LEDs 28 are disposed side by side in a reflector unit 17A attached to the base plate 11; and further that a control unit 29 is installed therein by which the white-light-emitting elements 12A and RBG-LEDs 28 are illuminated in white, red, blue, green or a combination of any of these colors. A lighting device 1E composed in this way can provide similar advantages to that according to the first preferred embodiment of the present invention, and also the lighting device 1E can be made to change or alter the illumination color.

It is also possible that two light-emitting elements, such as light-emitting diodes, of different colors are disposed in parallel configuration in the reflector 16.

Explained above are the embodiments of the present invention, wherein the lighting-device casing 21 forming the C-letter-shaped engagement-groove thereon is used. However, similar advantages can be provided by another embodiment, wherein an arc-shaped elastic support body 9 or 9A is integrally or separately formed inside the C-letter-shaped engagement-groove 20 of the lighting-device casing 21, whereas a mounting plate 7, 7A or 7B has the C-letter-shaped engagement-groove 20.

The present invention is applicable in the industry of manufacturing lighting devices.

1. A lighting device comprising:
a base plate;
a plurality of light-emitting elements evenly spaced at regular intervals in an in-line configuration on the base plate; and
a plurality of reflectors attached to the base plate, the plurality of reflectors being so formed as to cover each of the light-emitting diodes with mixed reflecting surfaces which are comprised of planar reflecting surfaces perpendicular to the in-line direction of the light-emitting elements and other side surfaces which are configured to mix reflected light from the light-emitting elements.

2. The lighting device comprising:
a base plate,
a plurality of light-emitting elements, evenly spaced at regular intervals in an in-line configuration on the base plate; and
a plurality of reflectors attached to the base plate, the plurality of reflectors being so formed as to cover each of the light-emitting diodes with mixed reflecting surfaces structured by reflecting surfaces which are planar except their lower portions, the planar reflecting surfaces being perpendicular to in-line direction of the light-emitting elements such as diodes, and the other side surfaces which are able to mix reflected lights from the light-emitting elements;
a lighting device casing wherein the plurality of reflectors and the base plate are covered by the lighting-device casing; and
a fitting, wherein the lighting casing is rotatable and adjustably attached to the fitting.

3. The lighting device according to claim 1 or 2, wherein
the other side surfaces are a plurality of arc-shaped surfaces.

4. The lighting device according to claim 1 or 2, wherein the plurality of reflectors are integrally molded.

5. The lighting device according to claim 3, wherein the plurality of reflectors are integrally molded.
